(19) United States
(12) Patent Application Publication
(10) Pub. No.: US 2023/0101162 A1
(43) Pub. Date: Mar. 30, 2023

(54) MOBILE BODY CONTROL DEVICE, MOBILE BODY, MOBILE BODY CONTROL METHOD, PROGRAM, AND LEARNING DEVICE

(71) Applicant: HONDA MOTOR CO., LTD., Tokyo (JP)

(72) Inventors: Sango Matsuzaki, Wako-shi, (JP); Yuji Hasegawa, Wako-shi (JP)

(21) Appl. No.: 17/951,140

(22) Filed: Sep. 23, 2022

(30) Foreign Application Priority Data
Sep. 30, 2021 (JP) 2021-161960

(51) Int. Cl. G05D 1/00; G05D 1/02

(52) U.S. Cl. CPC G05D 1/0088; G05D 1/0289

(57) ABSTRACT

A mobile body control device includes a route determination unit configured to determine a route of a host mobile body to reduce a change in a movement vector of another mobile body present in the vicinity of the host mobile body, and a control unit configured to move the host mobile body along the route determined by the route determination unit.

### CROSS-REFERENCE TO RELATED APPLICATION

Priority is claimed on Japanese Patent Application No. 2021-161960, filed on Sep. 30, 2021, the contents of which are incorporated herein by reference.

### BACKGROUND

### Field of the Invention

The present invention relates to a mobile body control device, a mobile body, a mobile body control method, a program, and a learning device.

### Background

In recent years, with the development of artificial intelligence (AI), research has been conducted to determine a route by reinforcement learning in an environment where autonomous mobile bodies are present together with human beings. However, robots and pedestrians frequently interfere with each other in a crowded traffic environment.

In relation to this, an invention of a route determination device that determines a route when an autonomous mobile robot moves to a destination under conditions present in traffic environments in which traffic participants including pedestrians reach destinations to take safe and secure avoidance action regarding the movement of people is disclosed (refer to PCT International Publication No. WO2020/136977). This route determination device includes a predicted route determination unit that uses a predetermined prediction algorithm and determines a predicted route, which is a predicted value of a route of a robot, to avoid interference between the robot and traffic participants, and a route determination unit that uses a predetermined control algorithm and determines the route of the robot to maximize an objective function, which includes a distance from the nearest traffic participant to the robot and the speed of the robot as independent variables, when it is assumed that the robot moves on a predicted route from a current position.

Also, in “Socially Aware Motion Planning with Deep Reinforcement Learning,” Yu Fan Chen, Michael Everett, Miao Liu, Jonathan P. How, 2017.3.26, <<https://arxiv.org/pdf/1703.08862.pdf>>, with respect to a reward function, creating the reward function and causing a robot to perform learning using a predetermined algorithm after considering three patterns of crossing, facing, and passing to improve cooperation with nearby people are disclosed.

Also, in “Mapless Navigation among Dynamics with Social-safety-awareness: a reinforcement learning approach from 2D laser scans,” Jun Jin, Nhat M. Nguyen, Nazmus Sakib, Daniel Graves, Hengshuai Yao, and Martin Jagersand, 2020.3.5., <<https://arxiv.org/pdf/1911.03074.pdf>>, with respect to a reward function, creating the reward function for the number of moving people and causing a robot to perform learning using a predetermined algorithm in overlapping areas in a traveling direction of each of the robot and people are disclosed.

### SUMMARY

In the conventional technology described above, since the effects of the mobile body on the actions of other mobile bodies in the vicinity are not taken into account, there are cases where it is not possible to take an action that has a high affinity with other mobile bodies in the vicinity. In addition, with a technology described in PCT International Publication No. WO 2020/136977, operations of other mobile bodies (routes of robots) are predicted, but it is difficult even with a current technology to accurately predict the operations of other mobile bodies.

An aspect of the present invention has an object to provide a mobile body control device, a mobile body, a mobile body control method, a program, and a learning device capable of causing a mobile body to take an action that has a high affinity with another mobile body in the vicinity without predicting a future operation of the other mobile body in the vicinity.

A mobile body control device according to a first aspect of the present invention includes a route determination unit configured to determine a route of a host mobile body to reduce a change in a movement vector of another mobile body present in a vicinity of the host mobile body, and a control unit configured to move the host mobile body along the route determined by the route determination unit.

A second aspect is the mobile body control device according to the first aspect described above, wherein the route determination unit may determine the route of the host mobile body to reduce a sum of changes in movement vectors of a plurality of other mobile bodies.

A third aspect is the mobile body control device according to the first or second aspect described above, wherein the route determination unit may determine the route of the host mobile body such that a value of a reward function having the change in the movement vector of the other mobile body as an independent variable is a good value.

A fourth aspect is the mobile body control device according to any one of the first to third aspects described above, wherein the route determination unit may determine the route of the host mobile body not to enter an area that is large in a direction of the movement vector of the other mobile body and is small in a sideward direction and an opposite direction of the direction of the movement vector of the other mobile body.

A mobile body according to a fifth aspect of the present invention includes the mobile body control device according to any one of the first to fourth aspects described above, a peripheral detection device configured to detect a surrounding environment, a working unit that provides a predetermined service to a user, and a drive unit that is controlled by the mobile body control device and moves a mobile body, wherein the mobile body control device outputs a control parameter that moves the mobile body by inputting a state of another mobile body based on the surrounding environment.

A mobile body control method according to a sixth aspect of the present invention includes, by a computer, determining a route of a host mobile body to reduce a change in a movement vector of another mobile body present in a vicinity of the host mobile body, and moving the host mobile body along the determined route.

A seventh aspect of the present invention is a computer-readable non-transitory recording medium that includes a program causing a computer to execute determining a route of a host mobile body to reduce a change in a movement vector of another mobile body present in a vicinity of the host mobile body, and moving the host mobile body along the determined route.

A learning device according to an eighth aspect of the present invention includes a simulation unit configured to simulate a movement operation of each of a host mobile body and another mobile body, an evaluation unit configured to evaluate at least a movement operation of the host mobile body by applying a reward function to a processing result of the simulation unit, and a learning unit configured to perform learning (on a preferred movement operation of the host mobile body) based on an evaluation result of the evaluation unit, wherein the evaluation unit evaluates the movement operation of the host mobile body to be higher as a change in a movement vector of the other mobile body is smaller.

A ninth aspect is the learning device according to the eighth aspect described above, wherein the evaluation unit may evaluate the movement operation of the host mobile body to be lower when the host mobile body enters an area that is large in a direction of the movement vector of the other mobile body and is small in a sideward direction and an opposite direction of the direction of the movement vector of the other mobile body.

According to the first to third and the fifth to seventh aspects, it is possible to move a mobile body while hindering movement of the other mobile body as little as possible without predicting a future operation of the other mobile body in the vicinity. As a result, it is possible to cause the mobile body to take an action that has a high affinity with the other mobile body in the vicinity.

According to the fourth aspect, it is possible to determine a route of the mobile body in consideration of personal space.

Thereby, according to the first to seventh aspects described above, it is possible to cause the mobile body to take an action that has a higher affinity with the other mobile body in the vicinity without predicting the future operation of the other mobile body in the vicinity.

According to the eighth aspect, it is possible to perform learning while hindering the movement of the other mobile body as little as possible without predicting the future operation of the other mobile body in the vicinity. As a result, it is possible to generate a policy that can cause the mobile body to take an action that has a high affinity with the other mobile body in the vicinity.

According to the ninth aspect described above, it is possible to perform learning in consideration of personal space.

Thereby, according to the eighth and ninth aspects described above, it is possible to perform learning for causing a mobile body to take an action that has a higher affinity with another mobile body in the vicinity without predicting a future operation of the other mobile body in the vicinity.

### BRIEF DESCRIPTION OF THE DRAWINGS

FIG. 1 is a schematic diagram which shows a system configuration of an embodiment.

FIG. 2 is a configuration diagram of a learning device.

FIG. 3 is a diagram for describing a reward function R₃.

FIG. 4 is a diagram for describing a reward function R₄.

FIG. 5 is a flowchart which shows an example of processing of a learning process of reinforcement learning performed by the learning device.

FIG. 6 is a configuration diagram of a mobile body.

### DESCRIPTION OF EMBODIMENTS

Hereinafter, embodiments of a mobile body control device, a mobile body, a mobile body control method, a program, and a learning device of the present invention will be described with reference to the drawings.

[Learning Device]

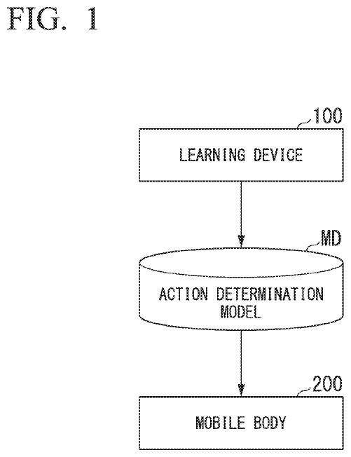

FIG. 1 is a schematic diagram which shows a system configuration of an embodiment. A mobile body control system 1 includes a learning device 100 and a mobile body 200. The learning device 100 is realized by one or more processors. The learning device 100 is a device that determines an action for a plurality of mobile bodies by computer simulation, derives or acquires a reward based on changes and the like in an environment caused by the action, and learns an action (operation) that maximizes the reward. An operation is, for example, movement within a simulation space. Although an operation other than movement may be set to be learned, it is assumed that the operation is movement in the following description. A simulator that determines movement (a simulation unit to be described below) may be executed in a device different from the learning device 100, but it is assumed that the learning device 100 executes the simulator in the following description. The learning device 100 preliminarily stores environment information such as map information, which is a premise of simulation. A result of learning by the learning device 100 is installed in the mobile body 200 as an action determination model MD.

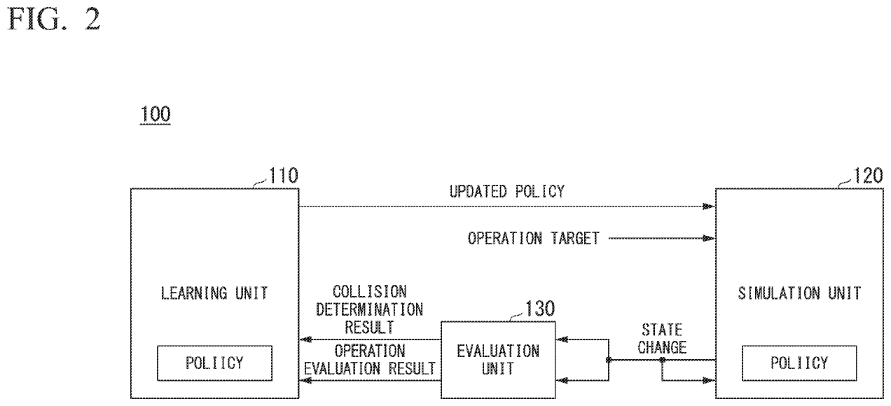

FIG. 2 is a configuration diagram of the learning device 100. The learning device 100 includes, for example, a learning unit 110, a simulation unit 120, and an evaluation unit 130. The learning device 100 is a device that inputs an operation target generated for a host agent (which is the host mobile body in the mobile body 200) to reach a certain destination, and a position, a movement direction, a movement speed, and the like of another agent (another mobile body) to a policy, performs reinforcement learning to update the policy on the basis of a result of evaluating a resulting state change (environmental change), and outputs a learned policy.

The host agent is a virtual operation subject that is assumed to be a mobile body such as a robot or a vehicle. Similarly, other agents are virtual operation subjects that are assumed to be mobile bodies such as robots and vehicles. Policies are also used to determine the operations of other agents, but the policies of other agents may or may not be updated.

The learning unit 110, the simulation unit 120, and the evaluation unit 130 are realized by a hardware processor such as a central processing unit (CPU) executing a program (software). The program may be stored in advance in a storage device (non-transitory storage medium) such as a hard disk drive (HDD) or flash memory, or may be stored in a removable storage medium (non-transitory storage medium) such as a digital versatile disc (DVD) or CD-ROM (read only memory) and installed by the storage medium being attached to a drive device. Some or all of these components may be realized by hardware (a circuit unit; including circuitry) such as a large scale integration (LSI), an application specific integrated circuit (ASIC), a field-programmable gate array (FPGA), or a graphics processing unit (GPU), or may be realized by software and hardware in cooperation.

The learning unit 110 updates the policy according to various reinforcement learning algorithms on the basis of an evaluation result of the evaluation unit 130 evaluating a state change generated by the simulation unit 120 and a result of the collision determination. The learning unit 110 repeatedly executes outputting the updated policy to the simulation unit 120 until learning is completed.

The simulation unit 120 inputs the operation target and a previous state (an initial state if immediately after a start of simulation) to the policy, and derives a state change, which is a result of the operations of the host agent and other agents. The policy is, for example, a deep neural network (DNN), but it may be another form of policy such as a rule-based policy. The policy derives a probability of occurrence for each of a plurality of types of assumed operations. For example, in a simple example, an assumed plane is set to spread vertically and horizontally, and a result of 80% rightward movement, 10% leftward movement, 10% upward movement, and 0% downward movement is output. The simulation unit 120 applies a random number to this result and derives the state changes of an agent such as rightward movement if a random value is 0% or more and less than 80%, leftward movement if the random value is 80% or more and less than 90%, and upward movement if the random value is 90% or more.

The evaluation unit 130 calculates a value (a reward function value) of a reward function R for evaluating a state change of the host agent output by the simulation unit 120, and evaluates an operation of the host agent.

The reward function R is, as shown in Equation (1), a reward function R₁ given when the host agent has reached a destination, a reward function R₂ given when the host agent has achieved smooth movement, a reward function R₃ that decreases when the host agent changes the movement vectors of other agents, and a reward function R₄ that varies a distance to be held when the host agent approaches other agents according to directions the other agents are facing. The reward function R₃ is an example of a first reward function, and the reward function R₄ is an example of a second reward function.

[Math 1]

R=R₁+R₂+R₃+R₄ (1)

The reward function R₁ is a function that has a positive fixed value when the destination is reached, and a value proportional to a change in distance to the destination when the destination is not reached (positive if the change in distance decreases and negative if the change increases).

The reward function R₂ is a function that has a value increasing as a third-order differential of a position of an agent on a two-dimensional plane, that is, a jerk (jolt), decreases.

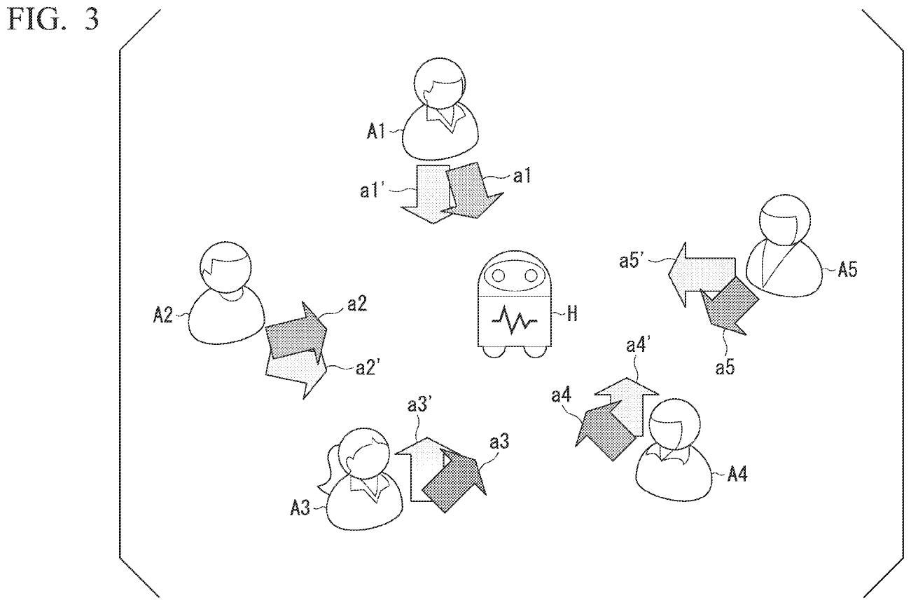

FIG. 3 is a diagram for describing the reward function R₃. The reward function R₃ calculated at a time (control cycle) t is a function in which movement vectors a′_{i,t} of other agents from a state of the other agents at a time t−1 to the time t (the movement vectors of the other agents when it is assumed that the host agent is not present) are compared with movement vectors a_{i,t} of the other agents from the state of the other agents at the time t−1 to the time t (the movement vectors of the other agents on a premise that the host agent is present) and, as a result, an evaluation value decreases as a difference between these increases. In other words, the reward function R₃ is a function in which the operation of the host agent is evaluated to be higher as the host agent does not change the movement vectors of the other agents in the vicinity. The reward function R₃ is an objective function that has changes in the movement vectors of the other agents as independent variables, and indicates that, for example, a larger value is a better value. The evaluation unit 130 may derive, by itself, the movement vector a′_{i,t} of the other agents from the state of the other agents at the time t−1 to the assumed time t when it is assumed that the host agent is not present, and may request the simulation unit 120 for the derivation.

$$\begin{matrix}[ Math 2 ] & \\ {R}_{3} = W \cdot {\sum }_{i}^{N} ‖ {a}_{i , t} - {a}_{i , t}^{′} ‖ & ( 2 )\end{matrix}$$

W in Equation (2) is a negative coefficient, or a function that returns a lower evaluation value as a value after Σ increases. a_{i,t} are the movement vectors of each of the other agents from the time t−1 to the time t (on the premise that the host agent is present), and a′_{i,t} are the movement vectors of each of the other agents from the time t−1 to the time t (when it is assumed that the host agent is not present). i is an identification number of the other agents, and N is the number of all the other agents who are present.

In FIG. 3, an agent H is the host agent, and agents A1 to A5 are the other agents. For example, at the time t, another agent A1 moves with a movement vector of a_{1,t}, another agent A2 moves with a movement vector of a_{2,t}, another agent A3 moves with a movement vector of a_{3,t}, another agent A4 moves with a movement vector of a_{4,t}, and another agent A5 moves with a movement vector of a_{5,t} On the other hand, the movement vectors derived when returning to the state at the time t−1 and assuming that the host agent H is not present are a′_{1,t} for the another agent A1, a′_{2,t} for the another agent A2, a′_{3,t} for the another agent A3, a′_{4,t} for the another agent A4, and a′_{5,t} for the another agent A5.

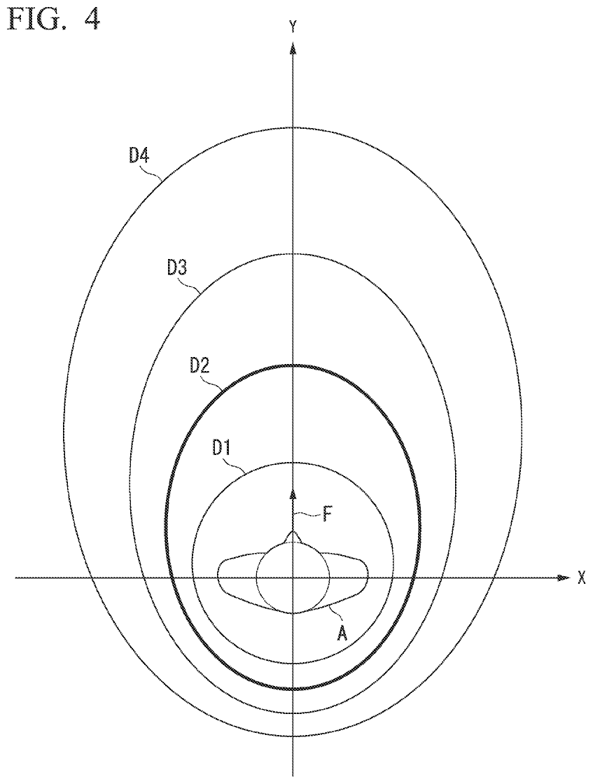

FIG. 4 is a diagram for describing a reward function R₄. The reward function R₄ is a function that returns a low evaluation value when the host agent enters a predetermined area. It is considered that an area in the vicinity of the another agent A is divided into the following four areas (spaces). For example, it is assumed to be divided into a close space surrounded by a boundary line D1, an individual space (personal space) surrounded by the boundary line D1 and a boundary line D2, a social space surrounded by the boundary line D2 and a boundary line D3, and a public space surrounded by the boundary line D3 and a boundary line D4.

In the present embodiment, for example, the reward function R₄ returns a low evaluation value when D2, which is an outer boundary of personal space, is entered. The personal space, like the social space and the public space, is wide in a direction (F) in which the another agent A is facing (or is moving), and narrow in other directions, based on the another agent A. As a result, actions that pass in front of the another agent A are given a low evaluation, and actions that pass the side of or behind the another agent A are given a moderate evaluation.

The evaluation unit 130 may determine that the host agent and the other agent have collided when coordinates of the host agent and the other agent match, or determine that the host agent and the other agent have collided when the host agent has entered a personal space of the other agent. When it is determined that they have collided, the evaluation unit 130 completes a current episode and initializes the state of each agent to start a next episode. The evaluation unit 130 outputs a result of the collision determination and a result of the operation evaluation to the learning unit 110. Details will be described in the flowchart.

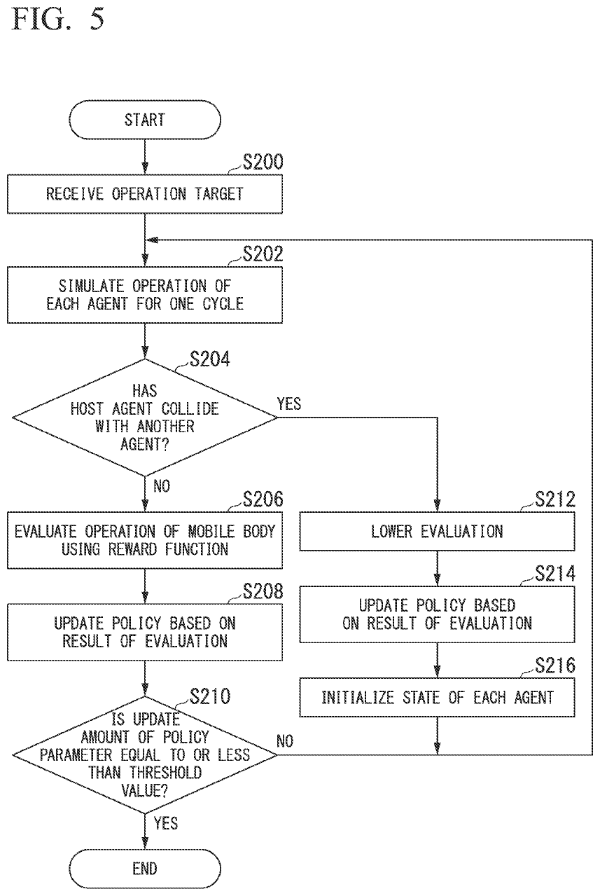

FIG. 5 is a flowchart which shows an example of processing of a learning process of reinforcement learning performed by the learning device 100.

First, the simulation unit 120 receives the operation target of the host agent from the learning device 100 (step S200). Next, the learning device 100 simulates an operation of each agent for one cycle using an operation target as one of inputs (step S202).

Next, the evaluation unit 130 determines whether the host agent and other agents have collided (step S204). When it is determined that the host agent and other surrounding agents do not collide, the evaluation unit 130 evaluates the operation of the host agent using the reward function R (step S206), and outputs a result of the evaluation to the learning unit 110.

Next, the learning unit 110 updates the policy according to a reinforcement learning algorithm based on the result of the evaluation by the evaluation unit 130 (step S208). The policy updated by the learning unit 110 is output to the simulation unit 120, and the simulation unit 120 uses the received policy to simulate the operation of each agent in a next cycle.

Next, the learning device 100 determines whether an update amount of a policy parameter each time is equal to or less than a threshold value on the basis of the state change that is a result of operations of the host agent and other agents (step S210). Here, the update amount of the parameter is, for example, an amount by which a parameter such as the movement vector of an nth host agent changes compared to a parameter such as the movement vector of an n−1th host agent, and is a sum of absolute values of the amount of change of the parameter, or the like. When the update amount of the policy parameter is less than or equal to a certain threshold m, that is, when the policy parameter has not changed much, the learning device 100 completes the processing of the learning process. When the update amount of the policy parameter is not equal to or less than the certain threshold m, the learning device 100 returns to step S202.

Alternatively, the learning process may be set to be completed when the processing for the predetermined number of cycles is completed.

When it is determined in step S204 that the host agent and other agents in the vicinity have collided, the evaluation unit 130 outputs the determination result to the learning unit 110 and lowers an evaluation value of the reward function (step S212). Then, the evaluation unit 130 outputs the evaluation result to the learning unit 110, and the learning unit 110 updates the policy based on the evaluation result of the evaluation unit 130 (step S214). Furthermore, the learning device 100 initializes the state of each agent and returns to step S202.

According to the learning device 100 described above, it is possible to generate an action determination model (policy) through reinforcement learning while hindering the actions of other mobile bodies in the vicinity as little as possible. Accordingly, the mobile body control device 250 that has employed the action determination model can cause the mobile body 200 to take an action that has a high affinity with the actions of other mobile bodies in the vicinity.

[Mobile Body]

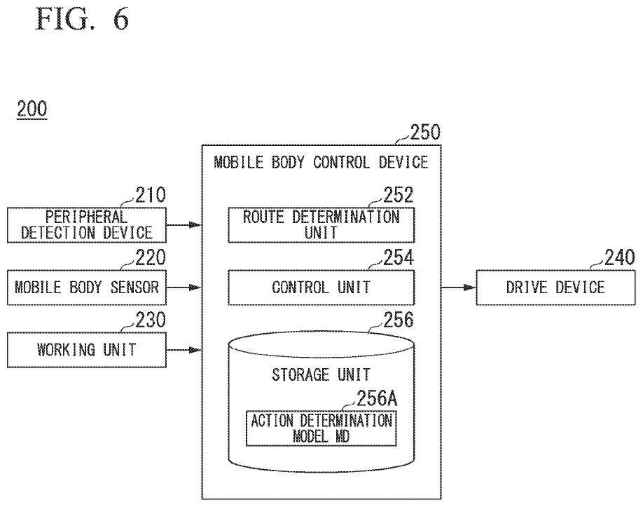

FIG. 6 is a configuration diagram of the mobile body 200. The mobile body 200 includes, for example, a mobile body control device 250, a peripheral detection device 210, a mobile body sensor 220, a working unit 230, and a drive device 240. The mobile body 200 may be a vehicle or a device such as a robot. The mobile body control device 250, the peripheral detection device 210, the mobile body sensor 220, the working unit 230, and the drive device 240 are connected to each other by multiple communication lines such as Controller Area Network (CAN) communication lines, serial communication lines, a wireless communication network, or the like.

The peripheral detection device 210 is a device for detecting an environment in the vicinity of the mobile body 200 and the operations of other mobile bodies in the vicinity. The peripheral detection device 210 includes, for example, a positioning device including a GPS receiver and map information, and an object recognition device such as a radar device and a camera. The positioning device measures the position of the mobile body 200 and matches the position with map information. The radar device radiates radio waves such as millimeter waves to the vicinity of the mobile body 200 and detects radio waves reflected by an object (reflected waves) to detect at least the position (distance and direction) of the object. The radar device may detect the position and movement vectors of the object. The camera is, for example, a digital camera using a solid-state imaging device such as a charge coupled device (CCD) or a complementary metal oxide semiconductor (CMOS), and is equipped with an image processing device that recognizes the position of an object from a captured image. The peripheral detection device 210 outputs information such as the position of the mobile body 200 on the map and the positions of objects (including other mobile bodies corresponding to other agents described above) present in the vicinity of the mobile body 200 to the mobile body control device 250.

The mobile body sensor 220 includes, for example, a speed sensor that detects a speed of the mobile body 200, an acceleration sensor that detects acceleration, a yaw rate sensor that detects an angular speed around the vertical axis, an orientation sensor that detects an orientation of the mobile body 200, and the like. The mobile body sensor 220 outputs a result of detection to the mobile body control device 250.

A working unit 230 is, for example, a device that provides a predetermined service to a user. The service herein is, for example, work such as loading and unloading of cargo and the like on transportation equipment. The working unit 230 includes, for example, a magic arm, a loading platform, a human machine interface (HMI) such as a microphone and a speaker, and the like. The working unit 230 operates according to instructions given by the mobile body control device 250.

A drive device 240 (drive unit) is a device for moving the mobile body 200 in a desired direction. When the mobile body 200 is a robot, the drive device 240 includes, for example, two or more legs and actuators. When the mobile body 200 is a vehicle, a micro-mobility, or a robot that moves on wheels, the drive device 240 includes wheels (steering wheels, driving wheels), and motors and engines for rotating the wheels.

The mobile body control device 250 includes, for example, a route determination unit 252, a control unit 254, and a storage unit 256. Each of the route determination unit 252 and the control unit 254 is realized by, for example, a hardware processor such as a CPU executing a program (software).

The program may be stored in advance in a storage device (non-transitory storage medium) such as an HDD or flash memory, or may be stored in a removable storage medium (non-transitory storage medium) such as a DVD or CD-ROM and installed by this storage medium being attached to a drive device. Some or all of these components may be realized by hardware (circuit unit; including circuitry) such as an LSI, ASIC, FPGA, or GPU, or may be realized by software and hardware in cooperation.

The storage unit 256 is, for example, an HDD, a flash memory, a RAM, a ROM, or the like. Information of an action determination model MD256A is stored in the storage unit 256, for example. The action determination model MD256A is based on a policy at an end of processing of a learning stage, generated by the learning device 100.

The route determination unit 252 inputs, for example, information (state of the object) such as the position of the mobile body 200 on the map and the positions of objects present in the vicinity of the mobile body 200, detected by the peripheral detection device 210, and furthermore information on a destination input by a user, to the action determination model MD256A, and determines a next position that the mobile body 200 travels next. The route determination unit 252 successively determines a route of the mobile body 200 by repeating this.

The control unit 254 controls the drive device 240 so that the mobile body 200 moves along the route determined by the route determination unit 252.

According to the mobile body control device 250 described above, it is possible to cause the mobile body 200 to take an action that has a high affinity with actions of other mobile bodies in the vicinity to generate a route for the mobile body 200 on the basis of an action determination model (policy) generated by reinforcement learning while hindering the actions of other mobile bodies in the vicinity as little as possible and move the mobile body 200 along the route.

In the present embodiment, it is assumed that the policy is updated only in the learning stage and is not updated after being installed in a mobile body, but learning may be continued even after it is installed in the mobile body.

As described above, a mode for implementing the present invention has been described using the embodiment, but the present invention is not limited to such an embodiment at all, and various modifications and replacements can be made within a range not departing from the gist of the present invention.

The embodiment described above can be expressed as follows.

A mobile body control device includes a storage device that has stored a program, and a hardware processor connected to the storage device, wherein the hardware processor executes the program, thereby determining a route of a host mobile body to reduce changes in movement vectors of other mobile bodies present in the vicinity of the host mobile body, and moving the host mobile body along the determined route.

The embodiment described above can be expressed as follows.

A learning device includes a storage device that has stored a program, and a hardware processor connected to the storage device, wherein the hardware processor executes the program, thereby simulating a movement operation of each of a host mobile body and other mobile bodies, applying a reward function to a result of the simulation to evaluate at least a movement operation of the host mobile body, performing learning on the basis of a result of the evaluation, and evaluating the movement operation of the host mobile body to be higher as changes in movement vectors of the other mobile bodies are smaller at the time of the evaluation.

What is claimed is:

1. A mobile body control device comprising:
a route determination unit configured to determine a route of a host mobile body to reduce a change in a movement vector of another mobile body present in a vicinity of the host mobile body; and
a control unit configured to move the host mobile body along the route determined by the route determination unit.

2. The mobile body control device according to claim 1,
wherein the route determination unit determines the route of the host mobile body to reduce a sum of changes in movement vectors of a plurality of other mobile bodies.

3. The mobile body control device according to claim 1,
wherein the route determination unit determines the route of the host mobile body such that a value of a reward function having the change in the movement vector of the other mobile body as an independent variable is a good value.

4. The mobile body control device according to claim 1,
wherein the route determination unit determines the route of the host mobile body not to enter an area that is large in a direction of the movement vector of the other mobile body and is small in a sideward direction and an opposite direction of the direction of the movement vector of the other mobile body.

5. A mobile body comprising:
the mobile body control device according to claim 1;
a peripheral detection device configured to detect a surrounding environment;
a working unit that provides a predetermined service to a user; and
a drive unit that is controlled by the mobile body control device and moves a mobile body,
wherein the mobile body control device outputs a control parameter that moves the mobile body by inputting a state of another mobile body based on the surrounding environment.

6. A mobile body control method comprising:
by a computer,
determining a route of a host mobile body to reduce a change in a movement vector of another mobile body present in a vicinity of the host mobile body; and
moving the host mobile body along the route.

7. A computer-readable non-transitory recording medium that includes a program causing a computer to execute:
determining a route of a host mobile body to reduce a change in a movement vector of another mobile body present in a vicinity of the host mobile body; and
moving the host mobile body along the route.

8. A learning device comprising:
a simulation unit configured to simulate a movement operation of each of a host mobile body and another mobile body;
an evaluation unit configured to evaluate at least a movement operation of the host mobile body by applying a reward function to a processing result of the simulation unit; and
a learning unit configured to perform learning based on an evaluation result of the evaluation unit,
wherein the evaluation unit evaluates the movement operation of the host mobile body to be higher as a change in a movement vector of the other mobile body is smaller.

9. The learning device according to claim 8,
wherein the evaluation unit evaluates the movement operation of the host mobile body to be lower when the host mobile body enters an area that is large in a direction of the movement vector of the other mobile body and is small in a sideward direction and an opposite direction of the direction of the movement vector of the other mobile body.
